(19) United States
(12) Patent Application Publication
(10) Pub. No.: US 2019/0303996 A1
(43) Pub. Date: Oct. 3, 2019

(54) SYSTEM AND METHOD FOR GENERATING MULTIPLE USER PROFILES FOR PERSONALIZED RECOMMENDATIONS

(71) Applicant: Myntra Designs Private Limited, Bangalore (IN)

(72) Inventors: Borar SUMIT, Bangalore (IN); Ghani Mohammed ABDULLA, Bangalore (IN); Sengupta SRIJIT, Bangalore (IN)

(73) Assignee: Myntra Designs Private Limited, Bangalore (IN)

(21) Appl. No.: 16/007,056

(22) Filed: Jun. 13, 2018

(30) Foreign Application Priority Data
Mar. 27, 2018 (IN) 201841011209

(51) Int. Cl. G06Q 30/06

(52) U.S. Cl. CPC G06Q 30/0631; G06N 99/005; G06Q 30/0609; G06Q 30/0635

(57) ABSTRACT

A system of an e-commerce platform for providing a plurality of services to a plurality of users is provided. The e-commerce platform includes a user account module configured to enable a user to create a unique user account and login to an e-commerce platform. The e-commerce platform also includes a service listing module configured to present a plurality of products to the user. In addition, the e-commerce platform includes a virtual shopping cart configured to enable the user to save one or more products for purchase. The products are purchased by using an external online payment module. Further, the system of the e-commerce platform includes a tagging module configured to enable the user to tag each product with a unique identifier. The product is tagged after it has been purchased by the user. In addition, the user account module is configured to generate a plurality of user profiles based on the tags provided by the user. The plurality of user profiles are linked to the unique user account.

### PRIORITY STATEMENT

The present application claims priority under 35 U.S.C. § 119 to Indian patent application number 201841011209 filed 27 Mar. 2018, the entire contents of which are hereby incorporated herein by reference.

### FIELD

Embodiments of the invention relate generally to e-commerce platforms and more particularly to a system and method for generating one or more user profiles within a user account for more personalized recommendations.

### BACKGROUND

A good user hereby experience is essential when it comes to e-commerce platforms. Having a top-notch user experience is paramount for both attracting and retaining customers. Most e-commerce platforms focus on the design details of their homepage, category pages, product pages and other critical e-commerce pages.

Most often, customers have a unique user account for the e-commerce site that they transact with. Therefore, e-commerce account pages are critical for building customer loyalty and for increasing sales through personalization.

In recent times, e-commerce websites are providing account pages to hold useful customer account information such as the demographic information, buying patterns, etc. Such data not only help the business organizations but also helps in creating a superior user experience that not only fosters loyalty but also saves time and minimizes the hassles.

It is often seen that a single user account could be used by one or more users such as other family members, friends and the like. However, there is no mechanism provided to segregate this information appropriately. This leads to less detailed customization and sometimes to inaccurate data collection. This may also lead to incorrect recommendation which is undesirable for the online retail industry.

Thus, there is a need for a more detailed user profiling that would result in more accurate data collection and seamless user experience and also assist in generating the right recommendation based the profile that is being serviced.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description. Example embodiments provide system and method for size and fit personalization at user profile level.

Briefly, according to an example embodiment, an e-commerce platform for providing a plurality of services to a plurality of users is provided. The e-commerce platform includes a user account module configured to enable a user to create a unique user account and login to an e-commerce platform. The e-commerce platform also includes a service listing module configured to present a plurality of products to the user. In addition, the e-commerce platform includes a virtual shopping cart configured to enable the user to save one or more products for purchase. The products are purchased by using an external online payment module. Further, the system of the e-commerce platform includes a tagging module configured to enable the user to tag each product with a unique identifier. The product is tagged after it has been purchased by the user. In addition, the user account module is configured to generate a plurality of user profiles based on the tags provided by the user. The plurality of user profiles are linked to the unique user account.

According to another example embodiment, an e-commerce platform for providing a plurality of services to a plurality of users is provided. The e-commerce platform includes a user account module configured to enable a user to create a unique user account. The user account module includes a user login module configured to create a unique user account for a user. The user account module also includes a user profile generator configured to create a plurality of user profiles associated to the unique user account. The user profiles are created based on a plurality of tags provided by the user. The e-commerce platform further includes a tracking module configured to track user account data and user profile data associated with the unique user account. In addition, the e-commerce platform includes a recommendation engine configured to generate personalized recommendations for the one or more user profiles associated with the unique user account.

In a further embodiment, an e-commerce platform for providing a plurality of services to a plurality of users is provided. The e-commerce platform includes an online retail interface configured to enable a plurality of users to interact with the e-commerce platform. The online retail interface includes an account login module configured to enable a user to login to the e-commerce platform. The online retail interface further includes a a service listing module configured to present a plurality of products to the user. In addition, the online retail interface includes a virtual shopping cart configured to enable the user to save one or more products for purchase. Further, the online retail interface includes a tagging module configured to enable the user to tag each product with a unique identifier; wherein the product is tagged after it has been purchased by the user. Furthermore, the e-commerce platform includes an online retail system coupled to the online retail interface. The online retail system includes a user account module. The user account module includes a user login module configured to create a unique user account for a user. In addition, the user account module includes a user profile generator configured to create a plurality of user profiles associated to the unique user account. The user profiles are created based on the tags provided by the user. The online retail system further includes a tracking module configured to track user account data and user profile data associated with the unique user account. Moreover the online retail system includes a recommendation engine configured to generate personalized recommendations for the one or more user profiles associated with the unique user account.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram of one embodiment of an e-commerce platform for generating one or more user profiles within a user account for more personalized recommendations, implemented according to the aspects of the present technique;

FIG. 2 is a flow diagram illustrating one method by which products are tagged by a user, implemented according to the aspects of the present technique;

FIG. 3 is a flow diagram illustrating one method by which personalized recommendations for each user profile within a user account, implemented according to the aspects of the present technique;

FIG. 4-A is an example screenshot illustrating a process of tagging a product with a user profile, implemented according to the aspects of the present technique;

FIG. 4-B is an example screenshot illustrating a process of adding details to the tagged user profile, implemented according to the aspects of the present technique;

FIG. 4-C is an example screenshot illustrating the user profile summary page for each user, implemented according to the aspects of the present technique;

FIG. 4-D is an example screenshot illustrating user profile level size recommendation, implemented according to the aspects of the present technique;

FIG. 4-E is an example screenshot illustrating a user profile switch for size recommendations, implemented according to the aspects of the present technique; and

FIG. 5 is a block diagram of an embodiment of a computing device in which the modules of the e-commerce platform for generating one or more user profiles within a user account for more personalized recommendations, described herein, are implemented.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled”. Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The systems described herein, may be realized by hardware elements, software elements and/or combinations thereof. For example, the devices and components illustrated in the example embodiments of inventive concepts may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

At least one example embodiment is generally directed to a system for providing plurality of products to a plurality of users on an e-commerce platform and more particularly to a system and method for generating one or more user profiles within a user account for more personalized recommendations.

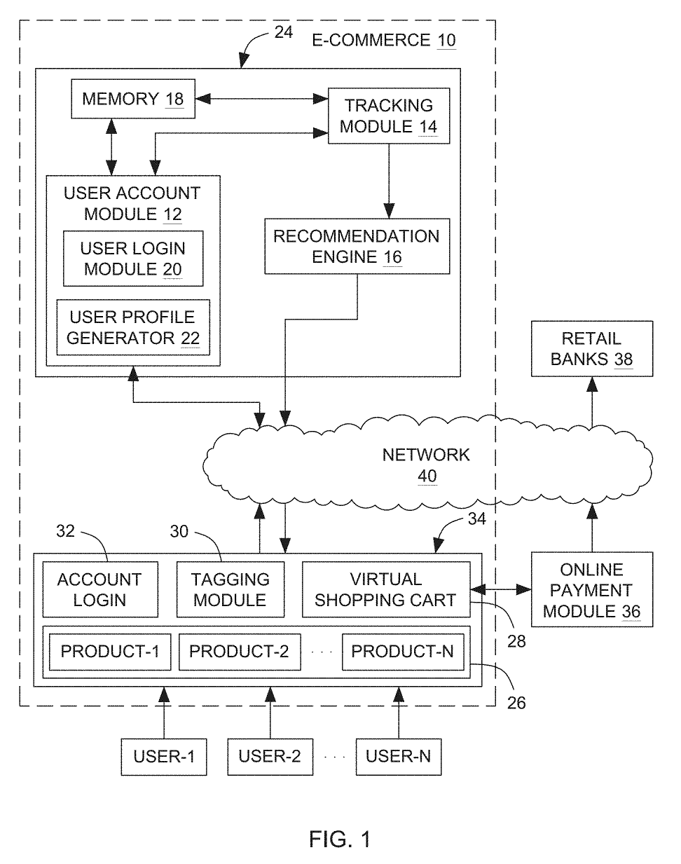

FIG. 1 is a block diagram of one embodiment of an e-commerce platform for generating one or more user profiles within a user account for more personalized recommendations, implemented according to the aspects of the present technique. The e-commerce platform 10 comprises an online retail system 24 and an online retail interface 34. For the purpose of this description, it is assumed that the e-commerce platform corresponds to the online fashion retail sector. It should be understood that the techniques described herein may be implemented in e-commerce platforms that cater to any sector such as grocery, electronics, books, etc. Each component is described in further detail below.

Online retail interface 34 enables a plurality of users to interact with the e-commerce platform to browse and/or purchase one or more products. The online retail interface 24 is configured to present a visual representation of a plurality of products (product-1 through product-N) with its associated cost, features and other details to the plurality of users (user-1 through user-N). The plurality of products (product-1 through product-N) are presented on a service listing module 26. In this specific embodiment, the plurality of products includes fashion apparel such as shirts, t-shirts, jeans, trousers, sweaters, jackets, sweatshirts, tunics and the like. The online retail interface 34 enables users-1 through user-N to log-in to an existing account or create a new account.

Online retail system 10 is coupled to the online retail interface 34 via network 40. The online retail system 10 includes a user account module 12, a tracking module 14, a recommendation engine 16, and a memory 18. The user account module 12 further includes a user login module 20 and a user profile generator 22. User login module 20 is configured to enable users (for example, user-1 through user-N) to create a unique user account on the e-commerce platform 10. In one embodiment, the memory 18 is configured to store data related to the plurality of user accounts. The user account data may include basic details such as user name, age, a preferred UserID, user address and the like.

As described earlier, user-1 through user-N are enabled to access the service listing module 26 comprising the plurality of products listed for purchase on the e-commerce platform 10 via the online retail interface 34. Users may browse products and add them to a virtual shopping cart 28 and further may proceed to purchase the selected products via an online payment module 36. The online payment module 36 is again coupled to the user's preferred bank account via network 40 and is configured to enable the user to make an online payment for the items purchased. It may be noted that the user may make payments using other payment modes such wallets, credit cards, or opt for paying cash on delivery.

Further, the online retail interface 34 includes a tagging module 30. The tagging module 30 enables the user to tag the purchased products with a unique identifier. In one embodiment, the unique identifier corresponds to a name of the person for whom the product was purchased. The tags provided by the user are received by the user account module 12. Upon receiving the tags, the user profile generator 22 is configured to create user profiles within the user account, where each user profile corresponds to a tag provided by the user. In an embodiment, each user profile is associated to each unique identifier or name. Therefore, under each user account, the user profile generator 22 is configured to generate one or more user profiles. In one embodiment, a user profile data corresponding to each user profile is stored in memory 18.

Tracking module 14 is configured to receive user account data and also the user profile data stored within each user account. For example, the user account data may include user-specific information about users over a period of time such as user's purchase history, date of purchase, the user's product ratings profile, current contents of the user's virtual shopping cart, a listing of products that were purchased recently or removed from the virtual shopping cart(s) without being purchased and so forth. Similarly, user profile data may include profile-specific information about the specific user profile such as size specific information, colour preferences and the like.

The tracking module 14 is configured to generate a profile vector for each user profile to track user account data. The tracking module 14 is configured to access user account data and user profile data. An observable feature vector for each product purchased by the user are generated. The observable feature vectors are generated using observable features such as physical measurements, type of material, a season type, an occasion type, colour, or combinations thereof of each of the products. In an embodiment, the observable feature vectors of the products purchased by each user are aggregated to compute an observable user vector for the respective user profile.

Further, a latent feature vector for each of the one or more products is generated using a skip gram-based technique. The latent feature vector is generated based upon latent features such as design information, brand information, a type of fit, or combinations thereof of each of the products. In some embodiments, the latent feature vectors are generated using a skip gram-based technique for frequently purchased products. In other embodiments, the latent feature vectors are generated using autoencoders for products which are frequently purchased. Autoencoders is a deep learning algorithm using neural networks to learn dense representation for each product. Such latent feature vectors of products purchased by each user are aggregated to compute a latent user vector for the respective user profile. In one embodiment, the aggregated data is used to standardize new sizes for products such as apparels to deduce common body shapes. In an embodiment, the data is identified and segregated as a profile vector for each user profile within one user account.

Recommendation engine 16 is configured to provide personalized recommendation to all user profiles associated with the user account using the observable vectors and latent feature vectors generated by the tracking module. In an embodiment, the recommendation engine is configured to generate the size and fitting recommendations using a Gradient Boost Classifier (GBC). In one embodiment, size and fitting recommendations for each user profile are generated based upon the observable feature vector, the observable user vector, latent feature vector and the latent user vector. In this embodiment, the size and fitting recommendation may include personalized size information across brands, fit type, brand type, or combinations thereof of the products for each user profile.

In another embodiment, the recommendation engine 16 is configured to generate recommendations for products that have not been purchased by the users yet but have a high probability of purchase by the user. Moreover, the recommendation engine 16 is configured to generate recommendations for products that have not been purchased by the user in the recent time, or within a specified time period. In an embodiment, the personalized recommendations are provided to the user based on the gender selected for the related user profile. In another embodiment, the discounts and promotions are based on the related user profile within the user account.

As mentioned above, each purchased products on the e-commerce platform is tagged by the user. The tags are used to generate user profiles within the user account and is further used for generating personalized recommendations. The manner in which this is achieved is described in further detail below.

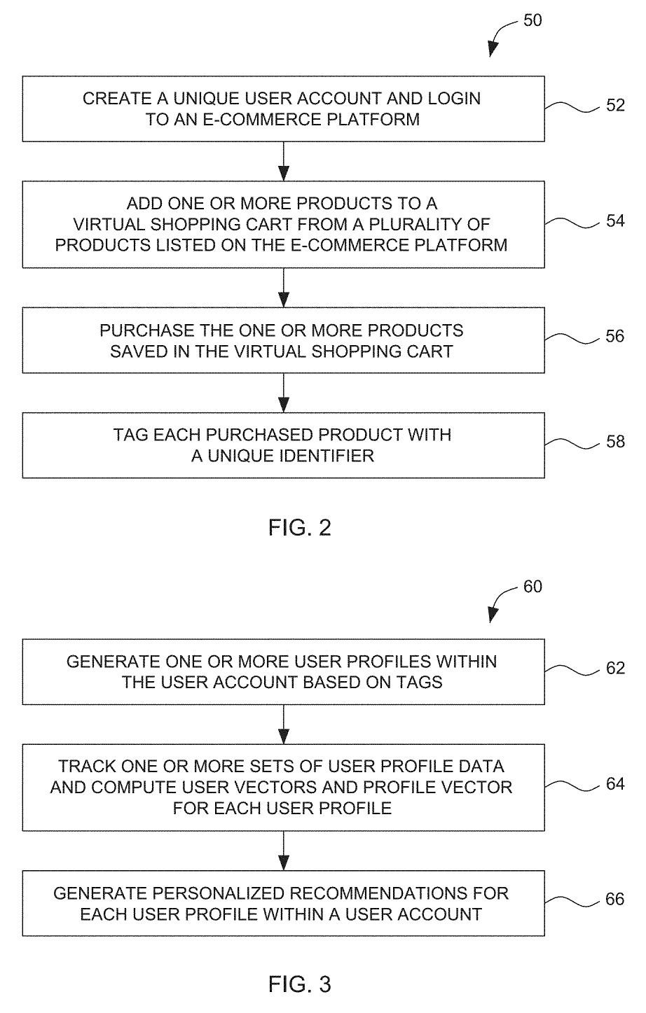

FIG. 2 is a flow diagram 50 illustrating one method by which products are tagged by a user, implemented according to the aspects of the present technique. The illustrated method is described with reference to an online fashion retail platform, however it should be understood by one skilled in the art that the techniques described herein may be implemented in all types of e-commerce platforms. Each step is described in further detail below.

At step 52, a user logs into an online fashion retail platform and a unique user account is created. In an embodiment, the user account may include basic details such as user name, userID, age, location, gender and the like. The user account may also include information related to personal preferences, saved payment details, purchase history, etc. for returning users.

At step 54, the user may browse a plurality of products listed on the fashion retail platform and add one or more products to a virtual shopping cart. The products may include a variety of fashion apparel, fashion accessories, etc. In a further embodiment, the user may add, edit or remove one or more products from the virtual shopping cart.

At step 56, the one or more products saved in the virtual shopping cart are processed for purchase. In an embodiment, the user is enabled to review the list of products added to the virtual shopping cart before proceeding to checkout and payment. In further embodiment, the user may be allowed to select a preferred mode of payment such as a preferred online bank, pay by cash, credit card, e-wallet and the like.

At step 58, after the payment has been processed, the user is provided the option of tagging each purchased product. In one embodiment, the user tags each purchased product with a unique identifier. In one embodiment, the unique identifier corresponds to a name of the person for whom the product was purchased. The user may be even asked to optionally provide more information regarding the unique identifier such as gender, age and relationship.

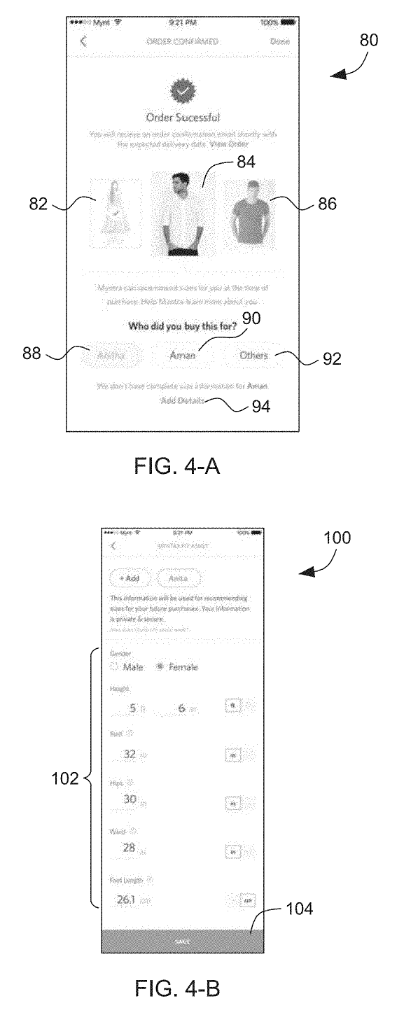

The information provided the by the user is then used to generate one or more user profiles within the user account. In one embodiment, each user profile corresponds to an individual within the user's social circle. Based on the user profiles created, the online retail system is configured to provide personalized recommendations to each user profiles associated with the user account. The manner in which the recommendations are generated is described in steps in FIG. 3 below.

FIG. 3 is a flow diagram 60 illustrating one method by which personalized recommendations for each user profile within a user account, implemented according to the aspects of the present technique. In one embodiment, the user profiles relate to individuals with the user's social circle. Each step is described in further detail below.

At step 62, one or more user profiles are generated within the user account created by the user. As described in FIG. 2, each user profile is created based on the tag provided by the user. In one embodiment, each user profiles within the user account may be added, edited or removed over time.

At step 64, one or more sets of user profile data within the user account, are tracked. As used herein, user profile data is associated to data related to a specific user profile within the user account. In an embodiment, an observable feature vector for each product purchased by the user are generated. The observable feature vectors are generated using observable features such as physical measurements, type of material, a season type, an occasion type, colour, or combinations thereof of each of the products. In an embodiment, the observable feature vectors of the products purchased by each user are aggregated to compute an observable user vector for the respective user profile.

Similarly, a latent feature vector is generated based upon latent features such as design information, brand information, a type of fit, or combinations thereof of each of the products. Such latent feature vectors of products purchased by each user are aggregated to compute a latent user vector for the respective user profile. In an embodiment, the data is identified and segregated as a profile vector for each user profile within one user account.

The tracking module 14 is configured to access user account data and user profile data. An observable feature vector for each product purchased by the user are generated. The observable feature vectors are generated using observable features such as physical measurements, type of material, a season type, an occasion type, colour, or combinations thereof of each of the products. In an embodiment, the observable feature vectors of the products purchased by each user are aggregated to compute an observable user vector for the respective user profile.

At step 66, personalized recommendations for the user profile within the user account are generated. In one embodiment, the personalized recommendations are based on the purchased items, preferred colours, sizes, and the like. In an embodiment, the size and fitting recommendations are generated using a Gradient Boost Classifier (GBC). In this embodiment, the recommendations include personalized size recommendation across brands, fit type, brand type, or combinations thereof of the products for each user profile.

The above described techniques are illustrated below with a few example screenshots. The screen shots are an exemplary implementation of enabling the user to tag the product and also an example illustration of a variety of recommended items.

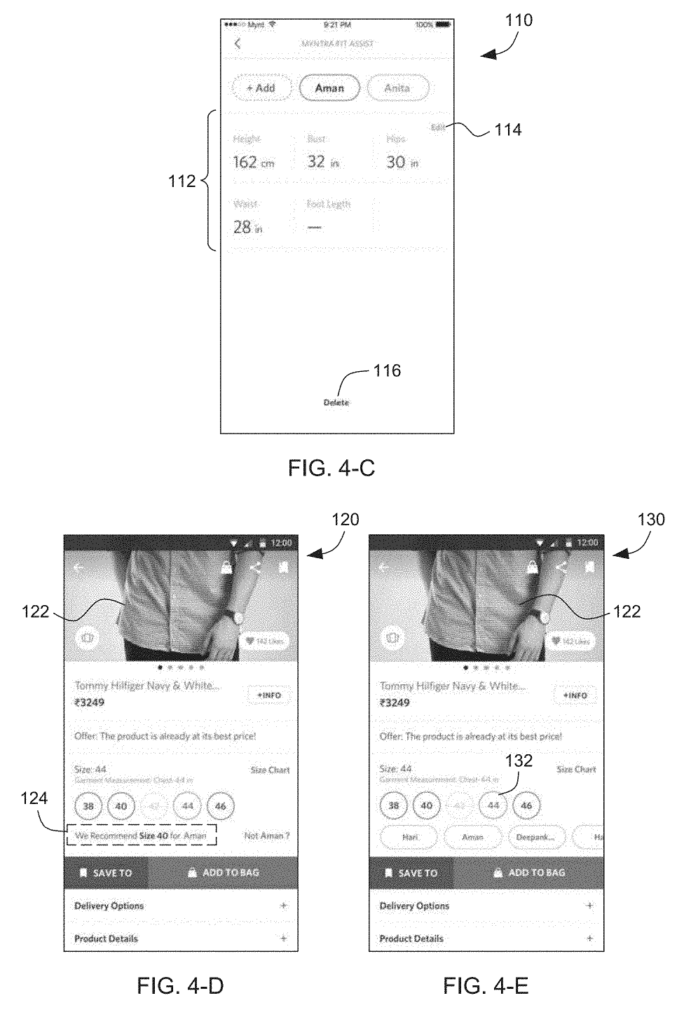

FIG. 4-A is an example screenshot 80 illustrating a process of tagging a product with a user profile, implemented according to the aspects of the present technique. In this example embodiment, one or more purchased products are represented by reference numerals 82 through 86. The user profile tags created within the user account are represented by reference numerals 88, 90 and 92. In this example embodiment, each user profile is associated to a unique identifier. The unique identifier includes a name (for example, ‘Aman’, ‘Anitha’) for whom the user profile is created. In this example embodiment, the user is enabled to tag purchased products 82, 84 and 86 with any one of the user profile tags 88, 90 and 92. Further, the user is also enabled to add more details to the selected user profile using ‘Add details’(94) option.

FIG. 4-B is an example screenshot 100 illustrating a process of adding details to the tagged user profile, implemented according to the aspects of the present technique. In this example, the user profile details associated with each user profile includes size and fit information, gender and the like. In the illustrated example, size and fitting details 102 for user profile ‘Anita’ includes Height, Bust, Hips, Waist, Foot Length and the like. Other details such as gender can be added or updated to the user profile tag. Further, the updated details can be saved using a ‘SAVE’ (104) button.

FIG. 4-C is an example screenshot 110 illustrating the user profile summary page for each user, implemented according to the aspects of the present invention. As shown in the FIG. 4-C, the summary of user details 112 is provided for each user profile. In an embodiment, the user is enabled to edit the user profile details using ‘Edit’ (114) option. The details may include height, bust, hips, waist, foot length and the like. In another embodiment, the user is enabled to delete the user profile by clicking on the ‘Delete’ (116) button.

FIG. 4-D is an example screenshot 120 illustrating user profile level size recommendation, implemented according to the aspects of the present technique. In this example embodiment, a size recommendation represented by 124 for a product 122 is provided for user profile ‘Aman’ on the product detail page. The user can add the product to the virtual cart without having to select the size or check the size chart.

FIG. 4-E is an example screenshot 130 illustrating a user profile switch for size recommendations, implemented according to the aspects of the present technique. In this example embodiment, the user is enabled to choose its required size and switch off the recommendation provided by the system. For example, user selects size 44 instead of size 40 which was recommended for ‘Aman’ on the product detail page.

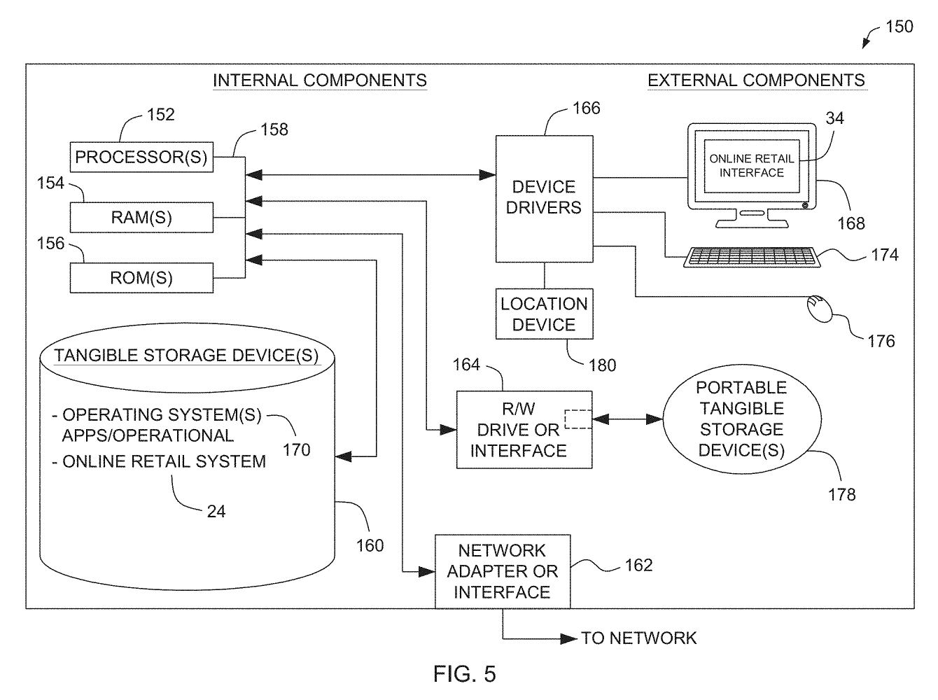

The modules of the online retail system 24 described herein are implemented in computing devices. One example of a computing device 150 is described below in FIG. 5. The computing device includes one or more processor 152, one or more computer-readable RAMs 154 and one or more computer-readable ROMs 156 on one or more buses 158. Further, computing device 150 includes a tangible storage device 160 that may be used to execute operating systems 170 and the online retail system 24. The online retail system 24 is coupled to the online retail interface 34 via network 40. The various modules of the online retail system 24 includes a user account module 12, a tracking module 14, a recommendation engine 16, and a memory 18. The user account module 12 further includes a user login module 20 and a user profile generator 22 and may be stored in tangible storage device 160. Both, the operating system 170 and the system 24 are executed by processor 152 via one or more respective RAMs 154 (which typically include cache memory). The execution of the operating system 170 and/or the system 24 by the processor 152, configures the processor 152 as a special purpose processor configured to carry out the functionalities of the operation system 170 and/or the online retail system 24, as described above.

Examples of storage devices 160 include semiconductor storage devices such as ROM 156, EPROM, flash memory or any other computer-readable tangible storage device that may store a computer program and digital information.

Computing device also includes a R/W drive or interface 164 to read from and write to one or more portable computer-readable tangible storage devices 178 such as a CD-ROM, DVD, memory stick or semiconductor storage device. Further, network adapters or interfaces 162 such as a TCP/IP adapter cards, wireless Wi-Fi interface cards, or 3G or 4G wireless interface cards or other wired or wireless communication links are also included in computing device.

In one example embodiment, the online retail system 24 is coupled to the online retail interface 34 via network 40. The various modules of the online retail system 24 includes a user account module 12, a tracking module 14, a recommendation engine 16, and a memory 18. The user account module 12 further includes a user login module 20 and a user profile generator 22 and may be stored in tangible storage device 160 and may be downloaded from an external computer via a network (for example, the Internet, a local area network or other, wide area network) and network adapter or interface 162.

Computing device further includes device drivers 166 to interface with input and output devices. The input and output devices may include a computer display monitor 168, a keyboard 174, a keypad, a touch screen, a computer mouse 176, and/or some other suitable input device.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The afore mentioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

1. An e-commerce platform for providing a plurality of services to a plurality of users, the e-commerce platform comprising:
a user account module configured to enable a user to create a unique user account and login to an e-commerce platform;
a service listing module configured to present a plurality of products to the user;
a virtual shopping cart configured to enable the user to save one or more products for purchase; wherein the products are purchased by using an external online payment module; and
a tagging module configured to enable the user to tag each product with a unique identifier; wherein the product is tagged after it has been purchased by the user; wherein the user account module is configured to generate a plurality of user profiles based on the tags provided by the user, and wherein the plurality of user profiles are linked to the unique user account.

2. The e-commerce platform of claim 1, further comprising a recommendation engine configured to provide personalized recommendations for the user profiles created and linked to each user account.

3. The e-commerce platform of claim 1, wherein the personalized recommendations comprise size information, fit type, brand type, or combinations thereof for the plurality of products.

4. The e-commerce platform of claim 1, wherein for each user profile, the user is enabled to provide user profile data, wherein the user profile data is used to refine the personalized recommendation provided by the recommendation engine.

5. An e-commerce platform for providing a plurality of services to a plurality of users, the e-commerce platform comprising:
a user account module comprising:
a user login module configured to create a unique user account for a user; and
a user profile generator configured to create a plurality of user profiles associated to the unique user account; wherein the user profiles are created based on a plurality of tags provided by the user;
a tracking module configured to track user account data and user profile data associated with the unique user account; and
a recommendation engine configured to generate personalized recommendations for the one or more user profiles associated with the unique user account.

6. The e-commerce platform of claim 5, wherein the tracking module is configured to generate an a profile vector for each user profile, wherein the profile vector comprises an observable feature vector and a latent feature vector.

7. The e-commerce platform of claim 6, wherein the latent feature vector is generated using autoencoders.

8. The e-commerce platform of claim 6, wherein the tracking module is further configured to aggregate a plurality of latent feature vectors corresponding to a plurality of products to generate aggregated data.

9. The e-commerce platform of claim 5, wherein the user profile data comprises size and fit data, preferences, purchase history, date of purchase, item ratings profile, contents of the user's virtual shopping cart, purchase history and the like.

10. The e-commerce platform of claim 5, wherein the recommendation engine is configured to generate personalized recommendations using a Gradient Boost Classifier (GBC).

11. The e-commerce platform of claim 10, wherein the personalized recommendations are provided to the user based on a selected user profile.

12. The e-commerce platform of claim 5, wherein the recommendation engine is further configured to provide discounts and promotions for each user profile within the user account.

13. An e-commerce platform for providing a plurality of products for purchase to a plurality of users, the e-commerce platform comprising:
an online retail interface configured to enable a plurality of users to interact with the e-commerce platform, the online retail interface comprising:
an account login module configured to enable a user to login to the e-commerce platform;
a service listing module configured to present a plurality of products to the user;
a virtual shopping cart configured to enable the user to save one or more products for purchase;
a tagging module configured to enable the user to tag each product with a unique identifier; wherein the product is tagged after it has been purchased by the user;
an online retail system coupled to the online retail interface and comprising:
a user account module comprising:
a user login module configured to create a unique user account for a user; and
a user profile generator configured to create a plurality of user profiles associated to the unique user account; wherein the user profiles are created based on the tags provided by the user;
a tracking module configured to track user account data and user profile data associated with the unique user account; and
a recommendation engine configured to generate personalized recommendations for the one or more user profiles associated with the unique user account.

14. The e-commerce platform of of claim 13, further comprising a recommendation engine configured to provide personalized recommendations for the user profiles created linked to each user account.

15. The e-commerce platform of claim 13, wherein the tracking module is configured to generate an a profile vector for each user profile, wherein the profile vector comprises an observable feature vector and a latent feature vector; and wherein the latent feature vector is generated using autoencoders.
